(19) United States
(12) Patent Application Publication
(10) Pub. No.: US 2026/0105006 A1
(43) Pub. Date: Apr. 16, 2026

(54) HYBRID VIRTUAL MACHINES HAVING PHYSICALLY BACKED AND VIRTUALLY BACKED MEMORY RANGES

(71) Applicant: Microsoft Technology Licensing, LLC, Redmond, WA (US)

(72) Inventors: Mehmet IYIGUN, Kirkland, WA (US); Yevgeniy M. BAK, Redmond, WA (US); Taylor STARK, Redmond, WA (US)

(21) Appl. No.: 18/915,781

(22) Filed: Oct. 15, 2024

(51) Int. Cl. G06F 12/1009; G06F 9/455

(52) U.S. Cl. CPC G06F 12/1009; G06F 9/45558; G06F 2009/45583

(57) ABSTRACT

A method executed within a virtual machine (VM) host computer system. The method includes, during a pre-execution phase of a VM, mapping a physical address (PA)-backed range of the VM’s guest-physical memory pages to host-physical addresses (HPAs) within the system memory of the VM host and mapping a virtual-address (VA)-backed range of the VM’s guest-physical memory pages to host-virtual addresses (HVAs). The method also includes, during an execution phase of the VM, performing intercept processing when the VM accesses a guest-physical address (GPA) within the VA-backed range to map a corresponding HVA to an HPA. This method enables memory oversubscription of the VM by the VM host via the VA-backed memory range. At the same time, the method provides the VM with access to a PA-backed memory range that can be utilized without the potential performance penalties associated with using the VA-backed range.

### BACKGROUND

Virtualization technologies have revolutionized the landscape of modern computing by enabling the abstraction of physical hardware resources. This abstraction allows multiple virtual machines (VMs) to run concurrently on a single physical machine, thus maximizing resource utilization and providing isolation between different workloads. Modern virtualization technologies are enabled by hypervisors, which create and manage VMs by distributing and controlling the underlying hardware resources. A hypervisor is a software layer between the physical hardware and the VMs, ensuring each VM operates independently and securely while efficiently allocating processor, memory, and storage resources.

Two prominent types of VMs in virtualization are physical address (PA)-backed VMs and virtual address (VA)-backed VMs, both of which utilize second-level address translation (SLAT). The first level of translation is from guest virtual addresses (GVAs) to guest physical addresses (GPAs), and the second level of translation is from GPAs to host physical addresses (HPAs). For PA-backed VMs, GPAs are mapped directly to HPAs when the VM is provisioned. These mappings are generally static, meaning that the GPAs exposed to the VM are typically fixed to particular HPAs for the entire lifecycle of the VM. This design provides near-native memory access performance, as the need for dynamic memory management and remapping by the hypervisor is minimized.

VA-backed VMs, on the other hand, introduce an additional layer of address indirection. For VA-backed VMs, GPAs are mapped to host virtual addresses (HVAs) instead of being directly mapped to HPAs. The hypervisor manages the HVAs and dynamically maps them to HPAs as needed. If an HVA does not have an associated HPA (e.g., because the memory page has not been accessed yet, or because the host has trimmed it to reclaim resources), the SLAT entry for the GPA is marked as “no access.” When the guest VM attempts to access a GPA marked as “no access,” a memory intercept is triggered, similar to a page fault. The hypervisor then allocates or retrieves the necessary HPA, establishes the GPA-to-HPA mapping, and updates the SLAT. This dynamic memory management allows VA-backed VMs to oversubscribe memory, provisioning more memory to the VM than is physically available on the host. However, this flexibility comes with additional overhead due to the memory intercepts and the extra layer of address translation (e.g., HVA to HPA), which may affect the VM’s memory access performance.

The subject matter claimed herein is not limited to embodiments that solve any disadvantages or that operate only in environments such as those described supra. Instead, this background is only provided to illustrate one example technology area where some embodiments described herein may be practiced.

### SUMMARY

In some aspects, the techniques described herein relate to methods, systems, and computer program products, including: identifying a first set of guest-physical memory pages within a VM address space to be backed by host-physical addresses (HPAs) corresponding to host-physical memory pages within a memory of the VM host computer system; mapping each guest-physical memory page in the first set of guest-physical memory pages to a different physical memory page within the memory, including, for each guest-physical memory page in the first set of guest-physical memory pages, mapping a corresponding guest-physical address (GPA) to a corresponding HPA; identifying a second set of guest-physical memory pages within the VM address space to be backed by host-virtual addresses (HVAs); mapping each guest-physical memory page in the second set of guest-physical memory pages to a different HVA, including, for each guest-physical memory page in the second set of guest-physical memory pages, mapping a corresponding GPA to a corresponding HVA; and during an execution phase of the VM at the VM host computer system, processing an intercept based on the VM accessing a GPA that is mapped to an HVA, including mapping the HVA to an HPA.

In some aspects, the techniques described herein relate to methods, systems, and computer program products, including: identifying a first set of guest-physical memory pages within a VM address space to be backed by HPAs corresponding to host-physical memory pages within the memory; mapping each guest-physical memory page in the first set of guest-physical memory pages to a different physical memory page within the memory, including, for each guest-physical memory page in the first set of guest-physical memory pages, mapping a corresponding GPA to a corresponding HPA; identifying a second set of guest-physical memory pages within the VM address space to be backed by HVAs; mapping each guest-physical memory page in the second set of guest-physical memory pages to a different HVA, including, for each guest-physical memory page in the second set of guest-physical memory pages, mapping a corresponding GPA to a corresponding HVA; and distinguishing the first set of guest-physical memory pages from the second set of guest-physical memory pages to the VM.

In some aspects, the techniques described herein relate to methods, systems, and computer program products, including: identifying a first set of guest-physical memory pages within a VM address space to be backed by HPAs corresponding to host-physical memory pages within a memory of the VM host computer system; mapping each guest-physical memory page in the first set of guest-physical memory pages to a different physical memory page within the memory, including, for each guest-physical memory page in the first set of guest-physical memory pages, mapping a corresponding GPA to a corresponding HPA; associating the first set of guest-physical memory pages with a virtual non-uniform memory access (NUMA) node that includes a compute resource; identifying a second set of guest-physical memory pages within the VM address space to be backed by HVAs; mapping each guest-physical memory page in the second set of guest-physical memory pages to a different HVA, including, for each guest-physical memory page in the second set of guest-physical memory pages, mapping a corresponding GPA to a corresponding HVA; associating the second set of guest-physical memory pages with a NUMA node that lacks any compute resource; and during an execution phase of the VM at the VM host computer system, processing an intercept based on the VM accessing a GPA that is mapped to an HVA, including mapping the HVA to an HPA.

This Summary introduces a selection of concepts in a simplified form that are further described below in the Detailed Description. This Summary is not intended to identify key features or essential features of the claimed subject matter, nor is it intended to be used to determine the scope of the claimed subject matter.

### BRIEF DESCRIPTION OF THE DRAWINGS

To describe how the advantages of the systems and methods described herein can be obtained, a more particular description of the embodiments briefly described supra is rendered by reference to specific embodiments thereof, which are illustrated in the appended drawings. These drawings depict only typical embodiments of the systems and methods described herein and are not, therefore, to be considered to be limiting in their scope. Systems and methods are described and explained with additional specificity and detail through the use of the accompanying drawings, in which:

FIG. 1 illustrates an example of a computer architecture that facilitates a hybrid virtualization model that maps one or more ranges of a virtual machine’s (VM’s) guest-physical memory addresses (GPAs) to host-physical memory addresses (HPAs) while mapping one or more other ranges of the VM’s GPAs to host-virtual memory addresses (HVAs);

FIGS. 2A-2C illustrate examples of hybrid mappings of VM GPAs to host HPAs; and

FIG. 3 illustrates a flow chart of an example of a method for provisioning a hybrid VM.

### DETAILED DESCRIPTION

While physical address (PA)-backed virtual machines (VMs) offer the advantage of direct physical memory access, they are limited by their inability to support memory oversubscription, restricting their flexibility in dynamic memory allocation scenarios. On the other hand, (VA)-backed VMs, though adept at memory oversubscription, suffer from performance degradation due to the overhead associated with memory intercepts/page faults. This dichotomy presents a challenge in simultaneously optimizing VM host memory management and VM memory access performance.

The embodiments described herein introduce a hybrid virtualization approach that leverages the strengths of both PA-backed and VA-backed guest-physical memory ranges. In particular, this hybrid virtualization approach maps the guest-physical memory addresses (GPAs) within portion(s) of a VM’s memory space to host-physical memory addresses (HPAs) directly (e.g., like a PA-backed VM). At the same time, the hybrid virtualization approach maps the GPAs within other portion(s) of the VM’s memory space to host-virtual memory addresses (HVAs) (e.g., like a VA-backed VM). By incorporating a hybrid model, the hybrid virtualization approach allows for memory oversubscription through VA-backed ranges while maintaining high performance for performance-critical VM operations with PA-backed ranges. This hybrid approach enables efficient and flexible VM host memory management without the performance penalties typically associated with VA-backed VMs.

To facilitate the efficient use of this hybrid model by a VM, in some embodiments, a virtualization stack communicates the distinct memory ranges to the VM, enabling the VM to favor using PA-backed range(s). One example relies on guest enlightenment, enabling a virtualization stack to communicate the ranges to a guest operating system (OS) via a VM bus. Another example relies on virtual non-uniform memory access (NUMA) nodes to implicitly communicate the ranges to the guest OS without guest enlightenment. In the example of virtual NUMA nodes, embodiments associate PA-backed ranges with a virtual NUMA node (or nodes) that includes a compute resource and associate VA-backed ranges with a virtual NUMA node (or nodes) lacking any compute resource. With this arrangement, contemporary NUMA-aware OSs typically favor using the PA-backed ranges because they are considered local (e.g., due to their association with available compute resources). At the same time, NUMA-aware OSs typically disfavor using VA-backed ranges because they are considered remote. As such, a modern OS will naturally favor using the more performant PA-backed memory range(s) over the less performant VA-backed ranges.

This strategic hybrid allocation of memory to a VM using both HPA-backed and HVA-backed ranges enhances memory management efficiency and performance, addressing the limitations of both PA-backed and VA-backed VMs. Through these innovations, the hybrid virtualization technique provides a robust solution for modern computing environments, balancing flexibility and performance to accommodate diverse application needs.

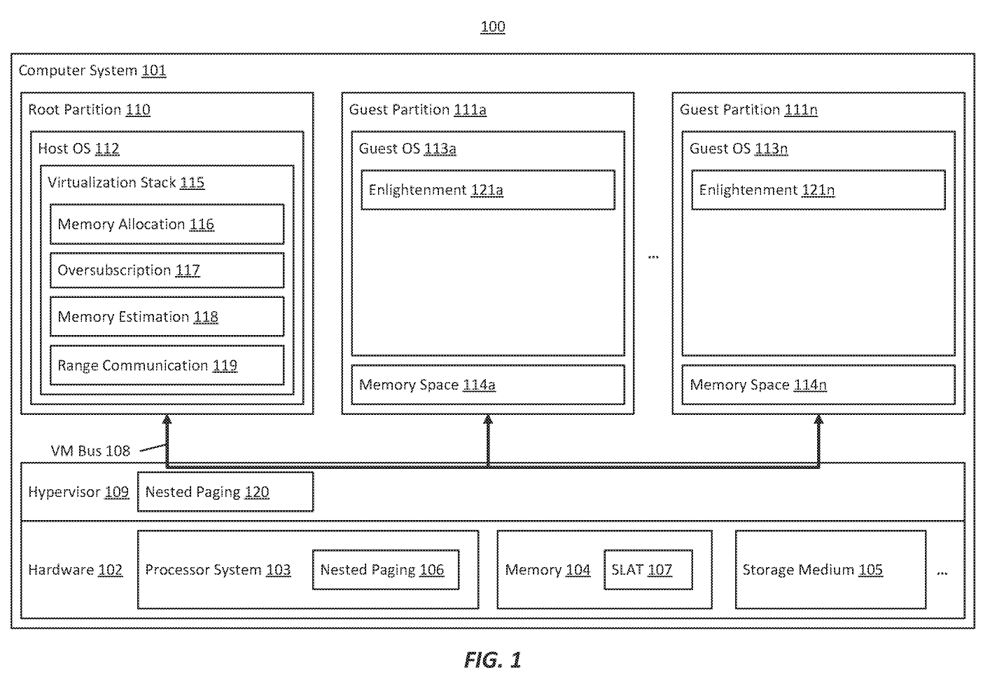

FIG. 1 illustrates an example of a computer architecture 100 that facilitates a hybrid virtualization model that maps one or more ranges of a VM’s GPAs to HPAs while mapping one or more other ranges of the VM’s GPAs to HVAs. Computer architecture 100 includes a computer system 101 comprising hardware 102. Examples of hardware 102 include a processor system 103 (e.g., a single processor or a plurality of processors), a memory 104 (e.g., system or main memory), and a storage medium 105 (e.g., a single computer-readable storage medium, or a plurality of computer-readable storage media). Computer system 101 can include a variety of hardware 102, such as a network interface (e.g., one or more network interface cards) for interconnecting to one or more other computer systems.

In computer architecture 100, a hypervisor 109 executes directly on hardware 102. In general, the hypervisor 109 partitions hardware resources (e.g., processor system 103, memory 104) among a root partition 110, within which a host OS 112 executes, as well as one or more guest partitions 111, or guest VMs, (e.g., guest partition 111a to guest partition 111n) within which guest OSs 113 execute (e.g., guest OS 113a in guest partition 111a to guest OS 113n in guest partition 111n). The hypervisor 109 also enables communications between partitions via a VM bus 108. The host OS 112 includes a virtualization stack 115, which manages guest VMs (e.g., memory management, VM guest lifecycle management, device virtualization) via one or more application program interface (API) calls to the hypervisor 109 via VM bus 108.

Computer architecture 100 illustrates a type-1 hypervisor architecture. Alternatively, a type-2 hypervisor architecture could be employed, where the hypervisor runs on top of a conventional host OS instead of directly on hardware. This setup lacks a root partition, and the type-2 hypervisor operates as an application within the host OS, utilizing the host’s existing resources and drivers for device management and hardware access. While this design simplifies deployment and leverages the host OS for hardware compatibility, it typically introduces additional overhead compared to type-1 hypervisors due to the reliance on the host OS for resource allocation and control.

In embodiments, processor system 103 includes a nested paging feature 106. This feature facilitates hardware-assisted memory virtualization by enabling an additional level of page table management, allowing the hypervisor 109 to manage guest memory more efficiently. This enhances the performance of VMs by reducing the overhead associated with translating a VM’s GPAs to the host’s physical memory. Examples of nested paging features can be found across different processor architectures, with specific implementations including EXTENDED PAGE TABLES (EPT) on INTEL processors, NESTED PAGE TABLES (NPT) on AMD processors, and stage-2 page tables on ARM processors. In a VA-backed VM configuration, GPAs are mapped to HVAs before being translated to HPAs. This is achieved using a second-level address translation (SLAT) mechanism, which introduces an additional mapping layer. Specifically, GPAs are translated to HVAs through the hypervisor’s virtual memory management. Then HVAs are further translated to HPAs using the nested page tables (represented by SLAT table 107 in FIG. 1). In FIG. 1, hypervisor 109 includes a nested paging component 120 that handles memory intercepts when a guest partition 111 attempts to access a memory page. The hypervisor uses the nested paging feature 106 to map the GPA to an HVA and then translate the HVA to an HPA, ensuring efficient memory management in a VA-backed environment.

Virtualization stack 115 is illustrated as including a memory allocation component 116. While conventional memory allocation components provision VMs that are either PA-backed or VA-backed, the memory allocation component 116 of FIG. 1 is also configured to provision individual hybrid VMs that are PA-backed as well as VA-backed. For example, in FIG. 1, each guest partition 111 is illustrated as having a memory space 114 (e.g., memory space 114a in guest partition 111a, memory space 114n in guest partition 111n). In the embodiments described herein, memory allocation component 116 configures a single VM memory space, such as memory space 114a, to include one or more PA-backed ranges having memory pages directly to HPAs and one or more VA-backed ranges having memory pages mapped to HVAs.

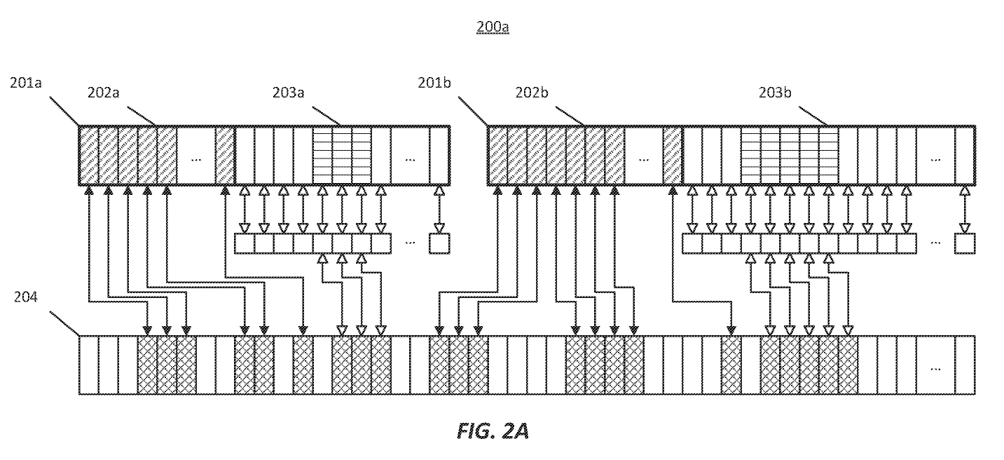

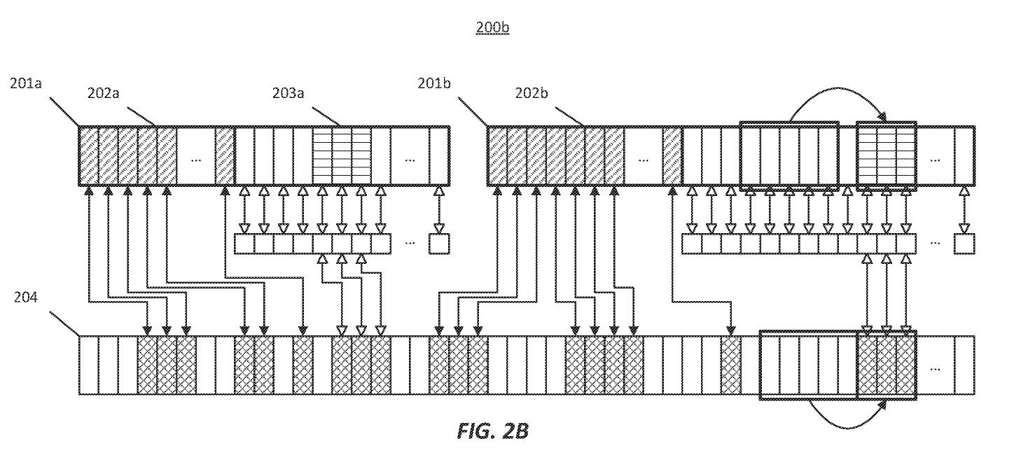

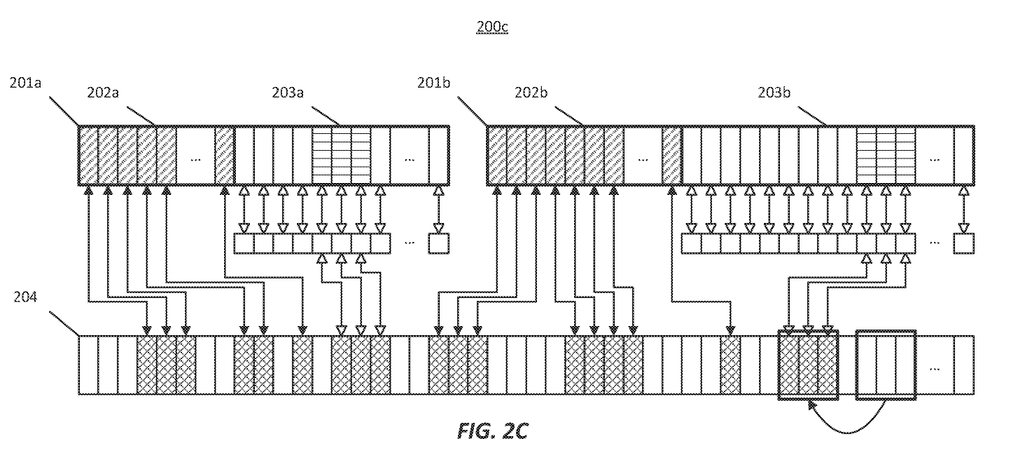

FIG. 2A illustrates an example 200a of hybrid mappings of VM GPAs to host HPAs, in which a single VM memory space includes mappings to HPAs and mappings to HVAs. In particular, FIG. 2A represents a VM memory space 201 for two different VMs, including VM memory space 201a and VM memory space 201b, as well as their mappings to a host memory space 204. In example 200a, each VM memory space 201 includes a PA-backed region 202 (e.g., PA-backed region 202a in VM memory space 201a and PA-backed region 202b in VM memory space 201b) and a VA-backed region 203 (e.g., VA-backed region 203a in VM memory space 201a and VA-backed region 203b in VM memory space 201b). Ellipses indicate that each memory space and/or region can be of any size, and the relative sizes indicated in FIG. 2A are non-limiting.

In FIG. 2A, solid-ended arrows indicate mappings between GPAs (e.g., from VM memory space 201a and VM memory space 201b) and HPAs (e.g., to host memory space 204). In FIG. 2A, open-ended arrows indicate mappings between GPAs (e.g., from VM memory space 201a and VM memory space 201b) and HVAs (shown as squares). In embodiments, memory allocation component 116 makes GPA-to-HPA and GPA-to-HVA mappings during the provisioning of a VM, and absent close coordination with the VM (e.g., to hot add or remove memory), those mappings remain in place during the lifecycle of the VM.

Open-ended arrows also indicate mappings between HVAs and HPAs. Typically, the hypervisor 109 (e.g., nested paging component 120) establishes these mappings when the VM attempts to access a VA-backed memory page that has not already been mapped to an HPA. In FIG. 2A, diagonal patterns within each VM memory space 201 indicate an active direct mapping to an HPA, while horizontal patterns within each VM memory space 201 indicate an active indirect (via an HVA) mapping to an HPA. A cross-hatch pattern within host memory space 204 indicates an active mapping to a GPA (either directly or via an HVA).

The PA-backed regions 202 typically remain actively mapped to host memory space 204 throughout a VM’s lifecycle. However, VA-backed regions 203 may have their HVA-to-HPA mappings changed at the discretion of the hypervisor 109 and/or the host OS 112. This arrangement enables a VM (e.g., guest partition 111a) to utilize PA-backed memory for performance-sensitive I/O operations. At the same time, this arrangement gives a VM host (e.g., computer system 101) flexibility in managing the allocation of physical memory to VMs.

For instance, in example 200b of FIG. 2B, the VM host has removed HVA-to-HPA mappings for a first block of memory pages within VA-backed region 203b and has added new HVA-to-HPA mappings for a second block of memory pages within VA-backed region 203b. For instance, if the VM associated with VM memory space 201b has stopped accessing the first block of memory pages for some time or has indicated that those mappings are no longer needed, the VM host may repurpose the corresponding physical memory pages (e.g., for another VM). Additionally, the new HVA-to-HPA mappings associated with the second block of memory pages may have been made due to the VM accessing GPAs associated with those memory pages. In example 200c of FIG. 2C, the VM host has chosen to alter which HPAs are mapped to a given set of HVAs (e.g., to free up a contiguous block of HVAs).

In FIG. 1, virtualization stack 115 also includes an oversubscription component 117. In embodiments, oversubscription component 117 enables computer system 101 to utilize VA-backed VM memory regions (including from fully VA-backed VMs and hybrid VMs) to oversubscribe the memory 104 at computer system 101. Using VA-backed memory regions, the totality of the memory space 114 allocated across one or more guest partitions can exceed the total amount of memory 104. This gives computer system 101 great flexibility in hosting more VMs than it would otherwise be capable of hosting. However, through hybrid VMs, computer system 101 can take advantage of memory oversubscription even with VMs with PA-backed memory ranges, which is impossible with traditional fully PA-backed VMs.

In FIG. 1, the virtualization stack 115 also includes a memory estimation component 118. In embodiments, memory allocation component 116 utilizes memory estimation component 118 to determine the size of the PA-backed region for a memory space 114. In embodiments, memory estimation component 118 determines an amount of memory anticipated as sufficient for typical memory use by a VM (guest partition 111) being provisioned. For example, the memory estimation component 118 may operate based on memory usage telemetry associated with VMs similarly configured to the one being provisioned, based on telemetry associated with a prior instance of the VM, or based on the workloads expected to be executed within the VM.

In FIG. 1, the virtualization stack 115 also includes a range communication component 119 that communicates, to a guest OS (e.g., guest OS 113a), an identification of the PA-backed range and the VA-backed range within a VM’s memory space (e.g., memory space 114a). The range communication component 119 may communicate this information either implicitly or explicitly.

In an example of implicit communication, the range communication component 119 configures a guest partition 111 to be backed by virtual NUMA nodes. In this configuration, the range communication component 119 associates the PA-backed range of the VM’s memory space with a NUMA node having a compute resource (e.g., a virtual processor) and associates the VA-backed range of the VM’s memory space with a NUMA node having no compute resource. With this configuration, a guest OS typically favors using the PA-backed range over the VA-backed range.

In an example of explicit communication, the range communication component 119 may communicate with a guest OS 113 via VM bus 108. For example, in FIG. 1, each guest OS 113 is illustrated as executing enlightenment 121, such as a driver (e.g., enlightenment 121a in guest OS 113a, enlightenment 121n in guest partition 111n). Based on the presence of the enlightenment 121, the range communication component 119 can expressly communicate the extent of the PA-backed and the VA-backed memory ranges to a guest OS 113.

While a hybrid VM would be operable without range communication component 119, using range communication component 119 can enable a VM’s guest OS to take advantage of its PA-backed memory. At the most basic level, the VM’s guest OS can prefer using PA-backed GPAs for its memory operations over VA-backed GPAs. Because using PA-backed GPAs does not include an additional HVA-GPA translation, memory operations directed to PA-backed GPAs tend to be faster than memory operations directed to VA-backed GPAs. This is particularly true if a VA-backed GPA lacks an HVA-to-HPA mapping, and that mapping needs to be created via a hypervisor intercept.

Even further, by knowing which GPAs are PA-backed versus VA-backed, a guest OS (or device driver operating on the guest OS) can make intelligent decisions relating to input/output (I/O) operations, such as a direct memory access (DMA) operations used to access directly assigned hardware devices. For example, when a VM’s guest OS/driver directs a DMA I/O operation at a GPA that is VA-backed, the guest OS/driver needs to “pin” that GPA for the duration of the I/O operation to ensure that the GPA-to-HPA translation doesn’t change during the I/O operation. To pin a GPA, the guest OS/driver calls into the hypervisor/host, making a request to lock a memory mapping. The hypervisor/host, in turn, ensures that the GPA-to-HPA translation remains fixed for as long as the DMA operation is in progress, preventing any dynamic changes that might otherwise occur in a virtualized environment where memory is often moved or remapped for efficiency. However, this pinning does not need to be done for PA-backed GPAs. In embodiments, a guest OS/driver omits pinning for DMA operations directed to PA-backed GPAs based on knowing which GPAs are PA-backed versus VA-backed.

Notably, hybrid VMs can improve I/O performance over purely VA-backed VMs when using synthetic (e.g., paravirtual) or emulated I/O devices, which requires that the host OS 112 carries out the operation on behalf of the VM. If an I/O operation using a synthetic/emulated I/O device references one or more GPAs in the VM’s VA-backed region, the host OS 112 needs to perform a probe-and-lock operation on one or more HVAs to ensure that HVA-to-HPA mappings don’t change while the host OS 112 performs the I/O on behalf of the VM. Without a probe-and-lock, memory remapping or paging events could occur during the operation, leading to instability or incorrect I/O behavior. In probe-and-lock, the host OS first probes the HVAs to verify that they are currently mapped to physical memory (HPAs). If not, it ensures the necessary memory is resident (e.g., not swapped out or paged). After probing, the host OS locks these HVAs to prevent their underlying HPA mappings from changing during the I/O operation. This ensures that the memory locations referenced by the VM remain consistent for the duration of the host’s I/O handling on behalf of the VM.

However, the host OS 112 can avoid probe-and-lock operations for I/O operations referencing GPAs in the VM’s PA-backed region. Notably, conventional VA-backed VMs lack any PA-backed region, so there is no opportunity to avoid host probe-and-lock operations for their synthetic/emulated I/O operations. In contrast, knowing which GPAs are PA-backed versus VA-backed (e.g., based on range communication component 119), an enlightened guest OS of a hybrid VM can ensure that I/O operations using synthetic/emulated devices reference the hybrid VM’s PA-backed GPAs rather than the VM’s VA-backed GPAs. This prevents probe-and-lock operations by the hypervisor/host and improves the synthetic I/O performance of hybrid VMs versus conventional VA-backed VMs.

In some embodiments, a hybrid VM actively communicates with the hypervisor 109 to inform the hypervisor’s management of HVA-to-GPA mappings. In one example, using the enlightenment 121, a guest OS may inform the hypervisor 109 of a set of VA-backed GPAs that are no longer being used (e.g., cold pages) so that the hypervisor 109 can repurpose the GPAs as needed. In another example, using the enlightenment 121, a guest OS may inform the hypervisor 109 of a set of VA-backed GPAs that will be used soon (e.g., hot pages) so that the hypervisor 109 can map their HVAs to GPAs before the guest OS attempts to access them, avoiding intercepts for the GPA accesses. In embodiments, based on information communicated by range communication component 119, the guest OS skips the communication of cold pages for PA-backed GPAs (e.g., because the host wouldn’t remove GPA to HPA mappings). Notably, this improves guest VM performance because it avoids the overheads of communicating with the hypervisor 109 and/or host OS 112.

In some embodiments, the virtualization stack 115 may cooperate with a guest partition (e.g., via enlightenment 121) to dynamically alter the PA and VA allocations during an execution phase of the VM. For example, after ensuring the VM is aware of the impending change and managing memory accordingly, the memory allocation component 116 may recharacterize PA-backed GPAs as being VA-backed or vice versa, changing the relative size of the PA-backed and VA-backed regions.

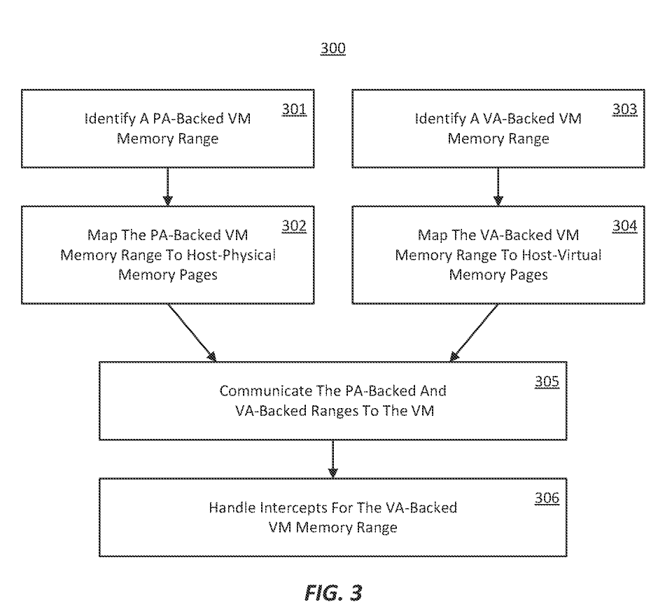

Embodiments are now described in connection with FIG. 3, which illustrates a flow chart of an example method 300 for provisioning a hybrid VM. In embodiments, instructions for implementing method 300 are encoded as computer-executable instructions (e.g., memory allocation component 116) stored on a computer storage medium (e.g., storage medium 105) that are executable by a processor (e.g., processor system 103) to cause a computer system (e.g., computer system 101) to perform method 300.

The following discussion now refers to a method and method acts. Although the method acts are discussed in specific orders or illustrated in a flow chart as occurring in a particular order, no order is required unless expressly stated or required because an act depends on another act being completed before the act being performed.

Referring to FIG. 3, in embodiments, method 300 comprises act 301 of identifying a PA-backed VM memory range. In some embodiments, act 301 identifies a first set of guest-physical memory pages within a VM address space to be backed by HPAs corresponding to host-physical memory pages within the memory. For example, in connection with provisioning guest partition 111a, memory allocation component 116 determines region(s) of memory space 114a to back with HPAs. Referring to FIG. 2A, if memory space 114a corresponds to VM memory space 201a, memory allocation component 116 determines that PA-backed region 202a is to be backed by HPAs.

Method 300 also comprises act 302 of mapping the PA-backed VM memory range to host-physical memory pages. In some embodiments, act 302 maps each guest-physical memory page in the first set of guest-physical memory pages to a different physical memory page within the memory, including, for each guest-physical memory page in the first set of guest-physical memory pages, mapping a corresponding GPA to a corresponding HPA. For example, memory allocation component 116 maps memory pages within the identified PA-backed region in memory space 114a to physical memory pages within memory 104. This includes mapping GPAs within memory space 114a to HPAs within memory 104. Referring to FIG. 2A, and as indicated by solid-ended arrows, memory allocation component 116 maps each memory page within PA-backed region 202a (each shown with a diagonal pattern to indicate an active mapping to an HPA) to a corresponding physical memory page within host memory space 204 (each shown with a cross-hatch pattern to indicate an active mapping to a VM memory space).

Method 300 also comprises act 303 of identifying a VA-backed VM memory range. In some embodiments, act 303 identifies a second set of guest-physical memory pages within the VM address space to be backed by HVAs. For example, in connection with provisioning guest partition 111a, memory allocation component 116 determines region(s) of memory space 114a to back with HVAs. In reference to FIG. 2A, if memory space 114a corresponds to VM memory space 201a, memory allocation component 116 determines that VA-backed region 203a is to be backed by HVAs. For example, memory allocation component 116 maps memory pages within VA-backed region 203a to intermediary virtual addresses. This includes mapping GPAs within memory space 114a to HVAs. Referring to FIG. 2A, and as indicated by open-ended arrows, memory allocation component 116 maps each memory page within PA-backed region 202a (each shown with a diagonal pattern to indicate an active mapping to an HPA) to a corresponding physical memory page within host memory space 204 (each shown with a cross-hatch pattern to indicate an active mapping to a VM memory space).

Method 300 also comprises act 304 of mapping the VA-backed VM memory range to host-virtual memory pages. In some embodiments, act 304 maps each guest-physical memory page in the second set of guest-physical memory pages to a different HVA, including, for each guest-physical memory page in the second set of guest-physical memory pages, mapping a corresponding GPA to a corresponding HVA. For example, memory allocation component 116 maps memory pages within the identified VA-backed region in memory space 114a to virtual addresses (HVAs). Referring to FIG. 2A, and as indicated by open-ended arrows, memory allocation component 116 maps each memory page within VA-backed region 203a to a corresponding HVA (indicated as squares).

Notably, in FIG. 3, no ordering is specified between acts 301-302 and 303-304. Thus, in various embodiments, these sets of acts could be performed serially (in either order) or at least partially in parallel. For example, some embodiments may perform acts 301 and 303 (potentially as part of a combined process) before performing acts 302 and 304 (potentially as part of a combined process).

In embodiments, acts 301-304 are performed during a pre-execution phase of a VM at the VM host computer system. For example, memory allocation component 116 may perform acts 301-304 as part of provisioning guest partition 111a, and before initiating the execution of virtual processors associated with guest partition 111a.

Notably, when performing acts 301 and 303, memory allocation component 116 may interoperate with oversubscription component 117 and/or memory estimation component 118. For example, when determining the size of the PA-backed range in act 301, memory allocation component 116 may rely on memory estimation component 118 to allocate a PA-backed range having a size anticipated to be sufficient for typical memory use by guest partition 111a (e.g., based on memory usage telemetry associated with similarly-configured guest partitions, or based on the workloads expected to be executed within guest partition 111a). Thus, for example, in some embodiments of act 301, identifying the first set of guest-physical memory pages within the VM address space comprises identifying a number of guest-physical memory pages to include in the first set of guest-physical memory pages based on estimating an amount of memory the VM will utilize during the execution phase of the VM. In another example, when determining the size of the VA-backed range in act 303, memory allocation component 116 may rely on oversubscription component 117 to determine that memory space 114a can have a size exceeding available memory within memory 104. Thus, for example, in act 303, identifying the second set of guest-physical memory pages within the VM address space comprises identifying a first number of guest-physical memory pages that exceeds a second number of physical memory pages within the memory available for allocation to the VM.

Method 300 also comprises act 305 of communicating the PA-backed and VA-backed ranges to the VM. In some embodiments, act 305 distinguishes the first set of guest-physical memory pages from the second set of guest-physical memory pages to the VM. For example, the range communication component 119 communicates, to guest OS 113a, an identification of the PA-backed range and the VA-backed range of the memory space 114a either implicitly or explicitly, enabling the guest OS 113a to distinctly identify memory ranges that are PA-backed from memory ranges that are VA-backed.

In an example of implicit communication, range communication component 119 configures guest partition 111a to be backed by virtual NUMA nodes. In this configuration, range communication component 119 associates the PA-backed range with a NUMA node having a compute resource (e.g., a virtual processor), and associates the VA-backed range with a NUMA node having no compute resource. With this configuration, guest OS 113a will typically favor using the PA-backed range over the VA-backed range. Thus, in some embodiments of act 305, distinguishing the first set of guest-physical memory pages from the second set of guest-physical memory pages to the VM comprises associating the first set of guest-physical memory pages with a virtual NUMA node that includes a compute resource; and associating the second set of guest-physical memory pages with a NUMA node that lacks any compute resource.

In an example of explicit communication, range communication component 119 may communicate with an enlightenment 121a operating at guest partition 111a via VM bus 108. Thus, in some embodiments of act 305, distinguishing the first set of guest-physical memory pages from the second set of guest-physical memory pages to the VM comprises sending a first indication that the first set of guest-physical memory pages are physical address-backed to a guest software enlightenment; and sending a second indication that the second set of guest-physical memory pages are virtual address-backed to the guest software enlightenment.

Method 300 also comprises act 306 of handling intercepts for the VA-backed VM memory range. In some embodiments, act 306 comprises processing an intercept based on the VM accessing a GPA that is mapped to an HVA, including mapping the HVA to an HPA. For example, based on guest OS 113a accessing a memory page in the VA-backed range of memory space 114a, nested paging component 120 at the hypervisor maps an HVA to an HPA within SLAT table 107. Referring to FIG. 2A, and as indicated by open-ended arrows, some memory pages within VA-backed region 203a are mapped to HPAs via HVAa. Each memory page in the VA-backed region 203a mapped to an HPA is shown with a horizontal pattern to indicate an active mapping to an HPA. In embodiments, act 306 is performed during an execution phase of a VM at the VM host computer system.

After performing method 300, including act 305, computer system 101 has enabled a hosted VM, such as guest partition 111a, to carry out several informed and intelligent memory operations. In one example, if the VM performs DMA (e.g., for accessing a directly assigned hardware device), the guest OS/driver may perform a probe-and-lock operation when performing DMA on the VA-backed memory ranges but omit the probe-and-lock operation when performing DMA on the PA-backed memory ranges. Thus, in some embodiments of method 300, guest software at the VM performs a probe-and-lock operation when performing DMA on the second set of guest-physical memory pages and omits the probe-and-lock operation when performing DMA on the first set of guest-physical memory pages.

In another example, when the VM performs an I/O operation using a synthetic/emulated I/O device, the VM can ensure that that I/O operation references PA-backed GPA(s) rather than VA-backed GPA(s), avoiding probe-and-lock operation(s) at the hypervisor/host. Thus, in some embodiments of method 300, guest software at the VM ensures that an I/O operation using a synthetic or emulated I/O device references a GPA in the first set of guest-physical memory pages in preference to a GPA in the second set of guest-physical memory pages.

In another example, a VM can communicate “cold” pages that computer system 101 can use for other purposes and “hot” pages that the VM will need soon. Thus, in some embodiments, method 300 further comprises receiving, from the VM, an indication of a GPA within the second set of guest-physical memory pages that can have an HVA to HPA mapping removed or receiving, from the VM, an indication of a GPA within the second set of guest-physical memory pages the VM will access.

In some embodiments, the virtualization stack 115 may cooperate with a guest partition (e.g., via enlightenment 121) to dynamically alter the PA and VA allocations during an execution phase of the VM. Thus, in some embodiments, method 300 further comprises, during the execution phase of the VM, identifying a guest-physical memory page within the first set of guest-physical memory pages as being part of the second set of guest-physical memory pages going forward, unmapping a GPA of the guest-physical memory page from a corresponding HPA, and mapping the GPA of the guest-physical memory page to a corresponding HVA. In embodiments, method 300 further comprises, during the execution phase of the VM, identifying a guest-physical memory page within the second set of guest-physical memory pages as being part of the first set of guest-physical memory pages going forward, unmapping a GPA of the guest-physical memory page from a corresponding HVA, and mapping the GPA of the guest-physical memory page to a corresponding HPA.

Alternatively or in addition to the other examples described herein, examples include any combination of the following:

Clause 1. A method implemented in a virtual machine (VM) host computer system that includes a processor system and a memory, comprising: during a pre-execution phase of a VM at the VM host computer system: identifying a first set of guest-physical memory pages within a VM address space to be backed by host-physical addresses (HPAs) corresponding to host-physical memory pages within the memory; mapping each guest-physical memory page in the first set of guest-physical memory pages to a different physical memory page within the memory, including, for each guest-physical memory page in the first set of guest-physical memory pages, mapping a corresponding guest-physical address (GPA) to a corresponding HPA; identifying a second set of guest-physical memory pages within the VM address space to be backed by host-virtual addresses (HVAs); and mapping each guest-physical memory page in the second set of guest-physical memory pages to a different HVA, including, for each guest-physical memory page in the second set of guest-physical memory pages, mapping a corresponding GPA to a corresponding HVA; and during an execution phase of the VM at the VM host computer system: processing an intercept based on the VM accessing a GPA that is mapped to an HVA, including mapping the HVA to an HPA.

Clause 2. The method of clause 1, wherein the method further comprises distinguishing the first set of guest-physical memory pages from the second set of guest-physical memory pages to the VM.

Clause 3. The method of clause 2, wherein distinguishing the first set of guest-physical memory pages from the second set of guest-physical memory pages to the VM comprises: associating the first set of guest-physical memory pages with a virtual non-uniform memory access (NUMA) node that includes a compute resource; and associating the second set of guest-physical memory pages with a NUMA node that lacks any compute resource.

Clause 4. The method of clause 2, wherein distinguishing the first set of guest-physical memory pages from the second set of guest-physical memory pages to the VM comprises: sending a first indication that the first set of guest-physical memory pages are physical address-backed to a guest software enlightenment; and sending a second indication that the second set of guest-physical memory pages are virtual address-backed to the guest software enlightenment.

Clause 5. The method of any of clause 2-4, wherein guest software at the VM ensures that an input/output (I/O) operation using a synthetic or emulated I/O device references a first GPA in the first set of guest-physical memory pages in preference to a second GPA in the second set of guest-physical memory pages.

Clause 6. The method of any of clause 2-5, wherein guest software at the VM: calls a hypervisor or host OS to perform a probe-and-lock operation when performing direct memory access (DMA) on the second set of guest-physical memory pages; and omits calling the hypervisor or host OS to perform the probe-and-lock operation when performing DMA on the first set of guest-physical memory pages.

Clause 7. The method of any of clause 1-6, wherein identifying the second set of guest-physical memory pages within the VM address space comprises identifying a first number of guest-physical memory pages that exceeds a second number of physical memory pages within the memory available for allocation to the VM.

Clause 8. The method of any of clause 1-7, wherein identifying the first set of guest-physical memory pages within the VM address space comprises identifying a number of guest-physical memory pages to include in the first set of guest-physical memory pages based on estimating an amount of memory the VM will utilize during the execution phase of the VM.

Clause 9. The method of any of clause 1-8, wherein the method further comprises receiving, from the VM, an indication of a GPA within the second set of guest-physical memory pages that can have an HVA to HPA mapping removed.

Clause 10. The method of any of clause 1-9, wherein the method further comprises receiving, from the VM, an indication of a GPA within the second set of guest-physical memory pages the VM will access.

Clause 11. The method of any of clause 1-10, wherein the method further comprises, during the execution phase of the VM: identifying a guest-physical memory page within the first set of guest-physical memory pages as being part of the second set of guest-physical memory pages going forward; unmapping a GPA of the guest-physical memory page from a corresponding HPA; and mapping the GPA of the guest-physical memory page to a corresponding HVA.

Clause 12. The method of any of clause 1-11, wherein the method further comprises, during the execution phase of the VM: identifying a guest-physical memory page within the second set of guest-physical memory pages as being part of the first set of guest-physical memory pages going forward; unmapping a GPA of the guest-physical memory page from a corresponding HVA; and mapping the GPA of the guest-physical memory page to a corresponding HPA.

Clause 13. A computer system, comprising: a processor system; a memory; and a computer storage medium that stores computer-executable instructions that are executable by the processor system to at least: identify a first set of guest-physical memory pages within a virtual machine (VM) address space to be backed by host-physical addresses (HPAs) corresponding to host-physical memory pages within the memory; map each guest-physical memory page in the first set of guest-physical memory pages to a different physical memory page within the memory, including, for each guest-physical memory page in the first set of guest-physical memory pages, mapping a corresponding guest-physical address (GPA) to a corresponding HPA; identify a second set of guest-physical memory pages within the VM address space to be backed by host-virtual addresses (HVAs); map each guest-physical memory page in the second set of guest-physical memory pages to a different HVA, including, for each guest-physical memory page in the second set of guest-physical memory pages, mapping a corresponding GPA to a corresponding HVA; and distinguish the first set of guest-physical memory pages from the second set of guest-physical memory pages to the VM.

Clause 14. The computer system of clause 13, wherein distinguishing the first set of guest-physical memory pages from the second set of guest-physical memory pages to the VM comprises: associating the first set of guest-physical memory pages with a virtual non-uniform memory access (NUMA) node that includes a compute resource; and associating the second set of guest-physical memory pages with a NUMA node that lacks any compute resource.

Clause 15. The computer system of clause 13, wherein distinguishing the first set of guest-physical memory pages from the second set of guest-physical memory pages to the VM comprises: sending a first indication that the first set of guest-physical memory pages are physical address-backed to a guest software enlightenment; and sending a second indication that the second set of guest-physical memory pages are virtual address-backed to the guest software enlightenment.

Clause 16. The computer system of any of clause 13-15, wherein guest software at the VM calls a hypervisor or host OS to perform a probe-and-lock operation when performing direct memory access (DMA) on the second set of guest-physical memory pages, and omits calling the hypervisor or host OS to perform the probe-and-lock operation when performing DMA on the first set of guest-physical memory pages.

Clause 17. The computer system of any of clause 13-16, wherein identifying the second set of guest-physical memory pages within the VM address space comprises identifying a first number of guest-physical memory pages that exceeds a second number of physical memory pages within the memory available for allocation to the VM.

Clause 18. The computer system of any of clause 13-17, wherein identifying the first set of guest-physical memory pages within the VM address space comprises identifying a number of guest-physical memory pages to include in the first set of guest-physical memory pages based on estimating an amount of memory the VM will utilize during an execution phase of the VM.

Clause 19. The computer system of any of clause 13-18, wherein the computer-executable instructions are also executable by the processor system to: receive, from the VM, an indication of a GPA within the second set of guest-physical memory pages that can have an HVA to HPA mapping removed; or receive, from the VM, an indication of a GPA within the second set of guest-physical memory pages the VM will access.

Clause 20. A computer storage medium that stores computer-executable instructions that are executable by a processor system of a virtual machine (VM) host computer system to at least: during a pre-execution phase of a VM at the VM host computer system: identify a first set of guest-physical memory pages within a VM address space to be backed by host-physical addresses (HPAs) corresponding to host-physical memory pages within a memory of the VM host computer system; map each guest-physical memory page in the first set of guest-physical memory pages to a different physical memory page within the memory, including, for each guest-physical memory page in the first set of guest-physical memory pages, mapping a corresponding guest-physical address (GPA) to a corresponding HPA; associate the first set of guest-physical memory pages with a virtual non-uniform memory access (NUMA) node that includes a compute resource; identify a second set of guest-physical memory pages within the VM address space to be backed by host-virtual addresses (HVAs); map each guest-physical memory page in the second set of guest-physical memory pages to a different HVA, including, for each guest-physical memory page in the second set of guest-physical memory pages, mapping a corresponding GPA to a corresponding HVA; and associate the second set of guest-physical memory pages with a NUMA node that lacks any compute resource; and during an execution phase of the VM at the VM host computer system: process an intercept based on the VM accessing a GPA that is mapped to an HVA, including mapping the HVA to an HPA.

Embodiments of the disclosure comprise or utilize a special-purpose or general-purpose computer system (e.g., computer system 101) that includes computer hardware, such as, for example, a processor system (e.g., processor system 103) and system memory (e.g., memory 104), as discussed in greater detail below. Embodiments within the scope of the present disclosure also include physical and other computer-readable media for carrying or storing computer-executable instructions and/or data structures. Such computer-readable media can be any available media accessible by a general-purpose or special-purpose computer system. Computer-readable media that store computer-executable instructions and/or data structures are computer storage media (e.g., storage medium 105). Computer-readable media that carry computer-executable instructions and/or data structures are transmission media. Thus, embodiments of the disclosure can comprise at least two distinctly different kinds of computer-readable media: computer storage media and transmission media.

Computer storage media are physical storage media that store computer-executable instructions and/or data structures. Physical storage media include computer hardware, such as random access memory (RAM), read-only memory (ROM), electrically erasable programmable ROM (EEPROM), solid state drives (SSDs), flash memory, phase-change memory (PCM), optical disk storage, magnetic disk storage or other magnetic storage devices, or any other hardware storage device(s) which store program code in the form of computer-executable instructions or data structures, which can be accessed and executed by a general-purpose or special-purpose computer system to implement the disclosed functionality.

Transmission media include a network and/or data links that carry program code in the form of computer-executable instructions or data structures that are accessible by a general-purpose or special-purpose computer system. A “network” is defined as a data link that enables the transport of electronic data between computer systems and other electronic devices. When information is transferred or provided over a network or another communications connection (either hardwired, wireless, or a combination thereof) to a computer system, the computer system may view the connection as transmission media. The scope of computer-readable media includes combinations thereof.

Upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module and eventually transferred to computer system RAM and/or less volatile computer storage media at a computer system. Thus, computer storage media can be included in computer system components that also utilize transmission media.

Computer-executable instructions comprise, for example, instructions and data which when executed at a processor system, cause a general-purpose computer system, a special-purpose computer system, or a special-purpose processing device to perform a function or group of functions. In embodiments, computer-executable instructions comprise binaries, intermediate format instructions (e.g., assembly language), or source code. In embodiments, a processor system comprises one or more central processing units (CPUs), one or more graphics processing units (GPUs), one or more neural processing units (NPUs), and the like.

In some embodiments, the disclosed systems and methods are practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. In some embodiments, the disclosed systems and methods are practiced in distributed system environments where different computer systems, which are linked through a network (e.g., by hardwired data links, wireless data links, or by a combination of hardwired and wireless data links), both perform tasks. As such, in a distributed system environment, a computer system may include a plurality of constituent computer systems. Program modules may be located in local and remote memory storage devices in a distributed system environment.

In some embodiments, the disclosed systems and methods are practiced in a cloud computing environment. In some embodiments, cloud computing environments are distributed, although this is not required. When distributed, cloud computing environments may be distributed internally within an organization and/or have components possessed across multiple organizations. In this description and the following claims, “cloud computing” is a model for enabling on-demand network access to a shared pool of configurable computing resources (e.g., networks, servers, storage, applications, and services). A cloud computing model can be composed of various characteristics, such as on-demand self-service, broad network access, resource pooling, rapid elasticity, measured service, and so forth. A cloud computing model may also come in the form of various service models such as Software as a Service (SaaS), Platform as a Service (PaaS), Infrastructure as a Service (IaaS), etc. The cloud computing model may also be deployed using different deployment models such as private cloud, community cloud, public cloud, hybrid cloud, etc.

Some embodiments, such as a cloud computing environment, comprise a system with one or more hosts capable of running one or more VMs. During operation, VMs emulate an operational computing system, supporting an OS and perhaps one or more other applications. In some embodiments, each host includes a hypervisor that emulates virtual resources for the VMs using physical resources that are abstracted from the view of the VMs. The hypervisor also provides proper isolation between the VMs. Thus, from the perspective of any given VM, the hypervisor provides the illusion that the VM is interfacing with a physical resource, even though the VM only interfaces with the appearance (e.g., a virtual resource) of a physical resource. Examples of physical resources include processing capacity, memory, disk space, network bandwidth, media drives, and so forth.

Although the subject matter has been described in language specific to structural features and/or methodological acts, it is to be understood that the subject matter defined in the appended claims is not necessarily limited to the described features or acts described supra or the order of the acts described supra. Rather, the described features and acts are disclosed as example forms of implementing the claims.

The present disclosure may be embodied in other specific forms without departing from its essential characteristics. The described embodiments are only illustrative and not restrictive. All changes that come within the meaning and range of equivalency of the claims are to be embraced within their scope.

When introducing elements in the appended claims, the articles “a,” “an,” “the,” and “said” are intended to mean there are one or more of the elements. The terms “comprising,” “including,” and “having” are intended to be inclusive and mean that there may be additional elements other than the listed elements. Unless otherwise specified, the terms “set,” “superset,” and “subset” are intended to exclude an empty set, and thus “set” is defined as a non-empty set, “superset” is defined as a non-empty superset, and “subset” is defined as a non-empty subset. Unless otherwise specified, the term “subset” excludes the entirety of its superset (i.e., the superset contains at least one item not included in the subset). Unless otherwise specified, a “superset” can include at least one additional element, and a “subset” can exclude at least one element.

What is claimed:

1. A method implemented in a virtual machine (VM) host computer system that includes a processor system and a memory, comprising:
identifying a first set of guest-physical memory pages within a VM address space to be backed by host-physical addresses (HPAs) corresponding to host-physical memory pages within the memory;
mapping each guest-physical memory page in the first set of guest-physical memory pages to a different physical memory page within the memory, including, for each guest-physical memory page in the first set of guest-physical memory pages, mapping a corresponding guest-physical address (GPA) to a corresponding HPA;
identifying a second set of guest-physical memory pages within the VM address space to be backed by host-virtual addresses (HVAs);
mapping each guest-physical memory page in the second set of guest-physical memory pages to a different HVA, including, for each guest-physical memory page in the second set of guest-physical memory pages, mapping a corresponding GPA to a corresponding HVA; and
during an execution phase of the VM at the VM host computer system, processing an intercept based on the VM accessing a GPA that is mapped to an HVA, including mapping the HVA to an HPA.

2. The method of claim 1, wherein the method further comprises distinguishing the first set of guest-physical memory pages from the second set of guest-physical memory pages to the VM.

3. The method of claim 2, wherein distinguishing the first set of guest-physical memory pages from the second set of guest-physical memory pages to the VM comprises:
associating the first set of guest-physical memory pages with a virtual non-uniform memory access (NUMA) node that includes a compute resource; and
associating the second set of guest-physical memory pages with a NUMA node that lacks any compute resource.

4. The method of claim 2, wherein distinguishing the first set of guest-physical memory pages from the second set of guest-physical memory pages to the VM comprises:
sending a first indication that the first set of guest-physical memory pages are physical address-backed to a guest software enlightenment; and
sending a second indication that the second set of guest-physical memory pages are virtual address-backed to the guest software enlightenment.

5. The method of claim 2, wherein guest software at the VM ensures that an input/output (I/O) operation using a synthetic or emulated I/O device references a first GPA in the first set of guest-physical memory pages in preference to a second GPA in the second set of guest-physical memory pages.

6. The method of claim 2, wherein guest software at the VM:
calls a hypervisor or host OS to perform a probe-and-lock operation when performing direct memory access (DMA) on the second set of guest-physical memory pages; and
omits calling the hypervisor or host OS to perform the probe-and-lock operation when performing DMA on the first set of guest-physical memory pages.

7. The method of claim 1, wherein identifying the second set of guest-physical memory pages within the VM address space comprises identifying a first number of guest-physical memory pages that exceeds a second number of physical memory pages within the memory available for allocation to the VM.

8. The method of claim 1, wherein identifying the first set of guest-physical memory pages within the VM address space comprises identifying a number of guest-physical memory pages to include in the first set of guest-physical memory pages based on estimating an amount of memory the VM will utilize during the execution phase of the VM.

9. The method of claim 1, wherein the method further comprises receiving, from the VM, an indication of a GPA within the second set of guest-physical memory pages that can have an HVA to HPA mapping removed.

10. The method of claim 1, wherein the method further comprises receiving, from the VM, an indication of a GPA within the second set of guest-physical memory pages the VM will access.

11. The method of claim 1, wherein the method further comprises, during the execution phase of the VM:
identifying a guest-physical memory page within the first set of guest-physical memory pages as being part of the second set of guest-physical memory pages going forward;
unmapping a GPA of the guest-physical memory page from a corresponding HPA; and
mapping the GPA of the guest-physical memory page to a corresponding HVA.

12. The method of claim 1, wherein the method further comprises, during the execution phase of the VM:
identifying a guest-physical memory page within the second set of guest-physical memory pages as being part of the first set of guest-physical memory pages going forward;
unmapping a GPA of the guest-physical memory page from a corresponding HVA; and
mapping the GPA of the guest-physical memory page to a corresponding HPA.

13. A computer system, comprising:
a processor system;
a memory; and
a computer storage medium that stores computer-executable instructions that are executable by the processor system to at least:
identify a first set of guest-physical memory pages within a virtual machine (VM) address space to be backed by host-physical addresses (HPAs) corresponding to host-physical memory pages within the memory;
map each guest-physical memory page in the first set of guest-physical memory pages to a different physical memory page within the memory, including, for each guest-physical memory page in the first set of guest-physical memory pages, mapping a corresponding guest-physical address (GPA) to a corresponding HPA;
identify a second set of guest-physical memory pages within the VM address space to be backed by host-virtual addresses (HVAs);
map each guest-physical memory page in the second set of guest-physical memory pages to a different HVA, including, for each guest-physical memory page in the second set of guest-physical memory pages, mapping a corresponding GPA to a corresponding HVA; and
distinguish the first set of guest-physical memory pages from the second set of guest-physical memory pages to the VM.

14. The computer system of claim 13, wherein distinguishing the first set of guest-physical memory pages from the second set of guest-physical memory pages to the VM comprises:
associating the first set of guest-physical memory pages with a virtual non-uniform memory access (NUMA) node that includes a compute resource; and
associating the second set of guest-physical memory pages with a NUMA node that lacks any compute resource.

15. The computer system of claim 13, wherein distinguishing the first set of guest-physical memory pages from the second set of guest-physical memory pages to the VM comprises:
sending a first indication that the first set of guest-physical memory pages are physical address-backed to a guest software enlightenment; and
sending a second indication that the second set of guest-physical memory pages are virtual address-backed to the guest software enlightenment.

16. The computer system of claim 13, wherein guest software at the VM calls a hypervisor or host OS to a probe-and-lock operation when performing direct memory access (DMA) on the second set of guest-physical memory pages, and omits calling the hypervisor or host OS to perform the probe-and-lock operation when performing DMA on the first set of guest-physical memory pages.

17. The computer system of claim 13, wherein identifying the second set of guest-physical memory pages within the VM address space comprises identifying a first number of guest-physical memory pages that exceeds a second number of physical memory pages within the memory available for allocation to the VM.

18. The computer system of claim 13, wherein identifying the first set of guest-physical memory pages within the VM address space comprises identifying a number of guest-physical memory pages to include in the first set of guest-physical memory pages based on estimating an amount of memory the VM will utilize during an execution phase of the VM.

19. The computer system of claim 13, wherein the computer-executable instructions are also executable by the processor system to:
receive, from the VM, an indication of a GPA within the second set of guest-physical memory pages that can have an HVA to HPA mapping removed; or
receive, from the VM, an indication of a GPA within the second set of guest-physical memory pages the VM will access.

20. A computer storage medium that stores computer-executable instructions that are executable by a processor system of a virtual machine (VM) host computer system to at least:
identify a first set of guest-physical memory pages within a VM address space to be backed by host-physical addresses (HPAs) corresponding to host-physical memory pages within a memory of the VM host computer system;
map each guest-physical memory page in the first set of guest-physical memory pages to a different physical memory page within the memory, including, for each guest-physical memory page in the first set of guest-physical memory pages, mapping a corresponding guest-physical address (GPA) to a corresponding HPA;
associate the first set of guest-physical memory pages with a virtual non-uniform memory access (NUMA) node that includes a compute resource;
identify a second set of guest-physical memory pages within the VM address space to be backed by host-virtual addresses (HVAs);
map each guest-physical memory page in the second set of guest-physical memory pages to a different HVA, including, for each guest-physical memory page in the second set of guest-physical memory pages, mapping a corresponding GPA to a corresponding HVA;
associate the second set of guest-physical memory pages with a NUMA node that lacks any compute resource; and
during an execution phase of the VM at the VM host computer system, process an intercept based on the VM accessing a GPA that is mapped to an HVA, including mapping the HVA to an HPA.
